(19) United States
(12) Patent Application Publication
(10) Pub. No.: US 2018/0213770 A1
(43) Pub. Date: Aug. 2, 2018

(54) COLLAPSIBLE ANIMAL DECOY

(71) Applicant: Flint Holdings, LLC, Hummelstown, PA (US)

(72) Inventors: Carroll J. Davis, Edgefield, SC (US); Jerry McPherson, Colstrip, MT (US)

(21) Appl. No.: 15/421,878

(22) Filed: Feb. 1, 2017

(51) Int. Cl. A01M 31/06; E04H 12/22

(52) U.S. Cl. CPC A01M 31/06; E04H 12/2215

(57) ABSTRACT

An animal decoy comprising a coil spring, where the coil spring is shaped to resemble at least a portion of a body of an animal, and an exterior fabric layer over at least a portion of the coil spring. The compressible coil spring inside the body is configured to expand to press the material into a shape of an animal torso when released and can be compressed to a generally flat position. The coil spring extends from a tail region to a lower neck region of the body. The body also includes a plurality of sleeves where each sleeve receives a pole to be inserted into the ground for support of the animal decoy. The animal decoy also includes a head and neck generally configured to resemble a three dimensional head and neck made of a solid material or of a construction similar to the body with an articulable neck.

### FIELD OF THE INVENTION

The present invention relates to collapsible animal decoys that are easy to break-down for transportation and are easy to set-up and move in the field due to their light weight and portability.

### BACKGROUND

Animal decoys to attract animals may be used when hunting or nature watching. There are many different types of decoys, for example, full-bodied replicas of deer, elk, and other big game decoys are available on the market. These full-bodied replicas tend to be constructed of various foams and/or plastics and can be bulky and difficult to transport into the field. Additionally, there are two-dimensional expandable decoys that show a photographic or realistic representation of an animal. When hunting game birds, such as ducks, geese, and turkeys, decoys which resemble the two or three-dimensional shape and coloration of the desired game bird may be utilized. To achieve a bird decoy with generally three-dimensional shape, solid or compressible bird decoys may be used. The solid bird decoys may have a molded outer surface created to mimic the real appearance of the animal being decoyed. Alternatively, the collapsible bird decoys may have an outer surface of the decoy with a printed picture showing a real depiction of an animal in order to mimic the appearance of the bird being decoyed.

While three-dimensional bird decoys are available in compressible or collapsible form with a printed picture on their surface, such a decoy does not exist for other, larger animals. There is an unfulfilled need for a collapsible decoy depicting medium to large animals, that is both realistic in appearance, and easy to transport and set-up/breakdown due to its light weight construction.

### SUMMARY

An animal decoy comprising a body made of a material and generally configured to resemble a three dimensional animal torso, the body including a plurality of sleeves; a compressible coil spring inside the body, with the spring configured to expand to press the material into a shape of the animal torso when released and which may be compressed to a generally flat position. The coil spring extending from a tail region of the body to a first lower neck region of the body, with the coil spring forming the body extending from the tail region to the first lower neck region of the body. The decoy also comprising a head and neck generally configured to resemble a three dimensional animal head and neck, where the head and neck is made of a unitary piece of a three-dimensional material, and where the head and neck portion is connected to the body by a connection, wherein the connection comprises a magnet. And a plurality of poles, each pole in the plurality of poles having a first end configured to be inserted into the ground for support of the animal decoy and a second end configured to be inserted into a sleeve of the plurality of sleeves.

Alternatively, the neck may be made of a second section of material and generally configured to resemble a three dimensional animal neck, where the neck comprises an adjustable support mechanism inside the neck which can be manually positioned into different stationary positions, and where the neck is connected to the body by a first connection, wherein the first connection comprises a first magnet. And the head is generally configured to resemble a three dimensional animal head, where the head is connected to the neck by a second connection, wherein the second connection comprises a second magnet.

In another embodiment, the neck and head are made of a second section of material and generally configured to resemble a three dimensional animal neck and head. A second compressible coil spring is inside the neck and head and is configured to expand to press the second section of material into a shape of the animal neck and head when released and may also be compressed to a generally flat position. The second coil spring extending from a second lower neck region located on the neck to a nose region located on the head, with the second coil spring forming the neck and head extending from the second lower neck region of the neck to the nose region of the head. The neck is connected to the body by a connection, wherein the first connection comprises a first magnet.

The animal decoy may also comprise a set of antlers removably coupled to a top area on the head of the animal decoy and a tail removably coupled to a tail region of the body of the animal decoy. Each of the antlers may have a magnet permanently attached to a bottom end of one of the antlers, wherein the magnet removably engages a piece of metal that is permanently attached to the top area on the head of the animal decoy. The tail may also have a magnet permanently attached to a bottom side of the tail, wherein the magnet removably engages the compressible coil spring inside the body of the animal decoy.

### BRIEF DESCRIPTION OF THE DRAWINGS

The detailed description is set forth with reference to the accompanying figures. The use of the same reference numbers in different figures indicates similar or identical items or features.

FIG. 1 illustrates a side view of an animal decoy with the internal structure shown, according to an embodiment.

FIG. 2 illustrates a side view of an animal decoy with the internal structure shown, according to another embodiment.

FIG. 3 illustrates a side view of an animal decoy in a feeding position with the internal structure shown, according to the embodiment shown in FIG. 2.

FIG. 4 illustrates a side view of an animal decoy with the internal structure shown, according to yet another embodiment.

FIG. 5 illustrates a perspective view of the animal decoy in a compressed form, according to an embodiment.

FIG. 6 illustrates a top view of an attachable tail, according to an embodiment.

FIG. 7 illustrates a bottom view of an attachable tail, according to an embodiment.

FIG. 8 illustrates a side view of an attachable tail, according to an embodiment.

### DETAILED DESCRIPTION

In various embodiments described herein, different types of animal decoys are described. In some embodiments, the decoy may be a deer decoy. For example, the deer decoy may have an exterior that shows a realistic representation of a deer. The realistic representation of the deer may be attained in a number of different ways. For example, the deer decoy may have a solid exterior that is molded and colored to resemble a deer. As another example, the deer decoy may have a soft fabric exterior and the soft fabric exterior may be imprinted with a realistic representation of a deer. Such a decoy could be either a two or three-dimensional representation of a deer.

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

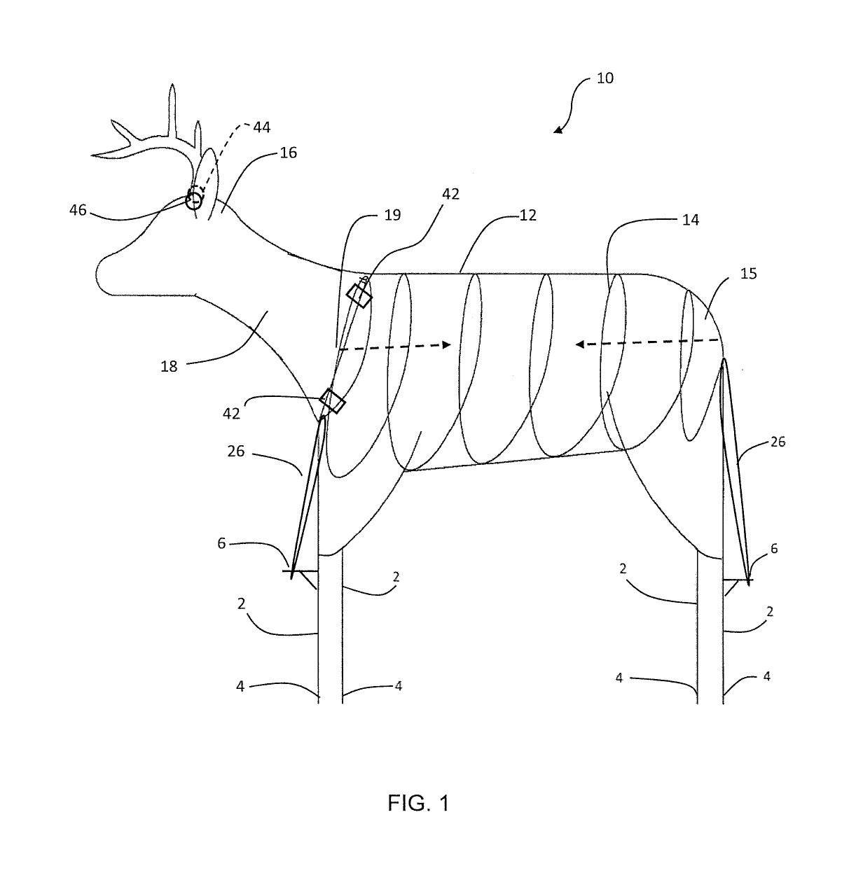

FIGS. 1-4 show several of the preferred embodiments of the invention. FIG. 1 illustrates a side view of a deer decoy 10 with the internal structure shown. The decoy 10 includes a body 12, which is a two dimensional fabric material that covers a coil spring 14. The two dimensional material that makes up the body 12 can be a fabric such as polyester, cotton, nylon, or any number of woven fabrics. The fabric is made as a hollow piece which can be folded flat unless it is pressed into a three-dimensional form by the expansion of the coil spring 14. The body 12 is configured to be the general shape of the torso of the animal which it is intended to imitate. Although the embodiments described herein describe a deer decoy, the animal decoy could be almost any animal, including predators. For example the animal decoy could be an elk, a moose, a wolf, a mountain lion, etc.

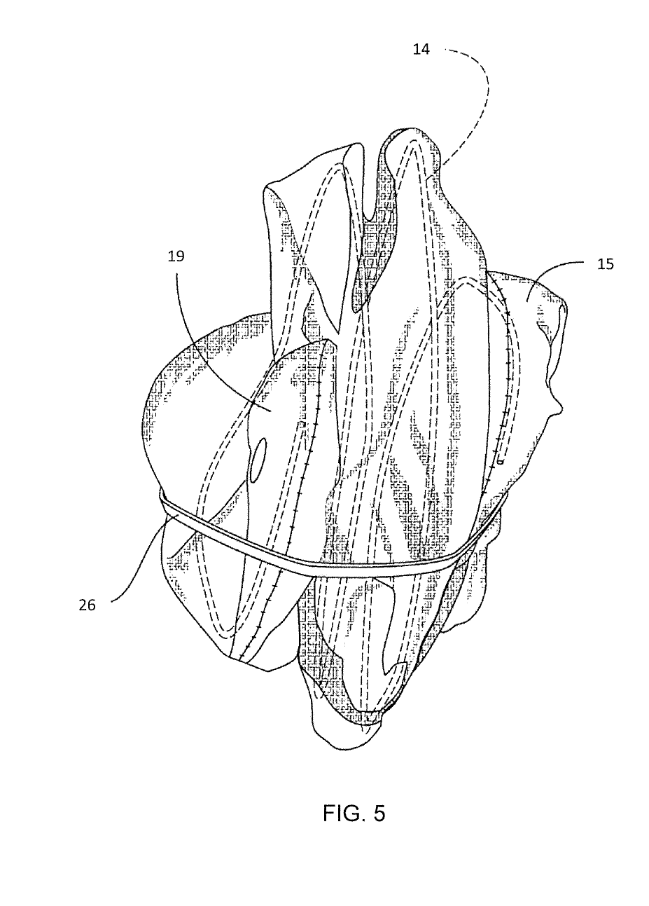

The coil spring 14 may be a steel spring, which extends depending upon the size of the animal being depicted. Likewise, the diameter of the steel spring can be modified depending on the type of animal being imitated. As an example, deer decoy 10, which is intended to be used in deer hunting, might have a coil spring in which the diameter of the coil itself is 16 inches, with the coil spring extending to approximately 3 feet or more when it is fully extended. The decoy 10 may also include a single or multiple storage straps 26, which can be a loop of elastic material. Once the body 12 of the decoy 10 is compressed so that the lower neck region 19 of the body 12 and the tail region 15 are pushed towards each other and the deer decoy 10 is basically flat, the storage straps 26 can be slipped over the flattened form, or otherwise connected to secure the flattened form, and the deer decoy can be stored and/or transported as a substantially flat dish shape. The dashed arrows in FIG. 1 show the direction of the force applied in order to compress the decoy 10. In the compressed form, as shown FIG. 5, the decoys can be stacked together and bundled for minimum storage space and ease in transport.

Parts of the decoy 10 may be pressed into a two dimensional shape by being stuffed with a material which intends to expand, yet is still compressible. For instance, in FIG. 1, the head 16 and the neck 18 can be filled with polyester batting, foam, down, or other materials which would tend to inflate the head 16 and the neck 18 to its full three-dimensional shape. Alternatively, the head and neck 16, 18 may be formed of a solid material, such as plastic or foam. This solid form would be molded and colored to provide a realistic imitation of the head and neck portion of a real deer. In another embodiment, the head 16 and the neck 18 may be formed of a flexible plastic material which is inflated to its three-dimensional shape via an internal inflatable bladder. In yet another embodiment, the head 16 and the neck 18 could be a taxidermy mount of a head and neck of a deer.

In the embodiment that uses a solid head 16 and neck 18, which could be formed in any one of the ways described above, the compressible body 12 can be attached to the neck 18 by any suitable means. As non-limiting examples, stitching, magnets, clips, zippers, or any combination of these could be used to removably, or permanently, connect the bottom of neck 18 to the lower neck region 19 of the body 12. Specifically, the base of neck 18 may be attached directly to the portion of the coil spring 14 located at the lower neck region 19 with thread or wire stitching. In an embodiment where the head 16 and neck 18 are made of a hard plastic material, magnets 42 may be molded into the base of the neck 18, in which case the magnets 42 then provide a removable attachment to the portion of the coil spring 14 located at the lower neck region 19.

In the embodiment that uses a solid head 16 and neck 18, as described above, the head 16 and neck 18 may be directly supported by the leg poles 2, which are described in greater detail below.

The decoy 10 may include leg poles 2 to be used for mounting, supporting, positioning and setting up the decoy 10. It should be noted, however, that the decoy 10 may be used without leg poles, and can be placed directly on the ground in order to imitate a deer in a bedded position. Each individual leg pole 2 may have a pointed bottom end 4 to facilitate staking the leg pole 2 into the ground. The leg pole 2 may have a blunt top end that can be inserted into the bottom side of the body 12 and inside leg pole sleeves, which may be located inside the deer decoy 10. Alternatively, the leg pole sleeves may be located externally on the outside of the decoy 10.

The leg poles 2 may be a solid pole, or may comprise a series of connectable shorter pole sections that may be kept together when disconnected by an internal elastic retaining cord. A perpendicular side piece 6 may be attached to the leg pole 2. The perpendicular side piece 6 may be used to push the pointed bottom end 4 of the leg pole 2 into the ground. Additionally, when the blunt top end of the leg pole 2 is in place inside one of the leg pole sleeves, the storage straps 26 can be attached to the perpendicular side piece 6 in order to secure the deer decoy 10 to the leg pole 2. The strap 26 can be constructed of a material with elastic properties, or any other suitable structure which provides adjustability. Alternatively, the strapping system used to store the decoy body 12 in its compressed or collapsed configuration can be separate from the straps used for securing the decoy 10 to the leg poles 2.

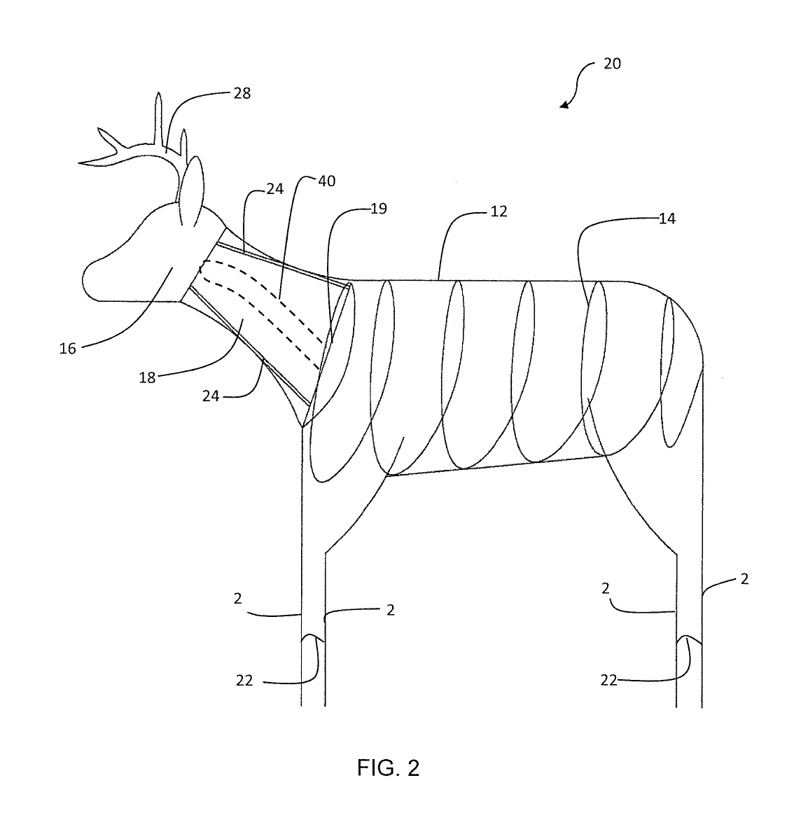

Different leg pole configurations are contemplated. For example, the animal decoy may only need two leg poles, one in the front and one in the back. The leg pole sleeves, if located externally on the body 12, or the body 12, if the leg pole sleeves are located internally, may be imprinted with a realistic representation of the animal decoy's 10 legs, giving the appearance that there are two front legs and two back legs even though only one leg pole is used for each. Alternatively, the leg poles may have a two-prong design, where the two front leg poles are connected together and the two back leg poles are connected together with a connection 22, as shown in FIG. 2. Connection 22 can be any suitable device for connecting two poles together. This could be a permanent connection, or some sort of removable connection. The blunt top ends of the two-prong leg poles may be inserted into two individual leg pole sleeves or a single, larger leg pole sleeve that can accommodate the top ends of the leg poles comprising the two-prong design.

The leg pole sleeves may be sewn into the internal cavity of the deer decoy 10. The leg pole sleeves may also be attached at an internal point of the deer decoy 10, such that the leg pole sleeves are prevented from moving within the generally hollow interior of the deer decoy 10. Each leg pole sleeve has an opening located on the bottom side of the deer decoy 10. The leg pole sleeves may extend fully inside the deer decoy 10. Alternatively, the leg pole sleeves may be sewn to the outside of fabric material that makes up the outer surface of the body 12. The top of the leg pole sleeves may include a heavy strip of strap material which helps to buffer the blunt top end of the leg pole 2 from pushing up and showing on the outside back of the deer decoy 10. The leg pole sleeves may also be sewn such that the blunt end of the leg pole 2 will be stopped a certain distance from the end of the sleeve which also helps prevent the leg pole 2 from poking up through the back of the deer decoy 10. In an embodiment with a solid head 16 and neck 18, the front leg poles may extend through open ended front leg pole sleeves and connect to the neck 18 thereby providing support directly to the solid head and neck.

According to another embodiment, FIG. 2 illustrates a side view of a deer decoy 20 with the internal structure shown. Deer decoy 20 has many of the features described in relation to deer decoy 10, however, deer decoy 20 includes one or a plurality of support mechanisms 24 that are located internally in the neck 18. In this embodiment, only the head 16 would be filled with polyester batting, foam, down, or other materials which would tend to inflate the head 16 to its full three-dimensional shape. Alternatively, the head 16 may be formed of a solid material, such as plastic or foam. This solid form would be molded and colored to provide a realistic imitation of the head of a real deer.

In one embodiment illustrated in FIG. 2, the neck 18 may be constructed similar to the body 12, in that a two dimensional fabric material that covers the support mechanisms 24 is made as a hollow piece which can be folded flat unless it is expanded into a three-dimensional form by attaching one end to the bottom of head 16 and the other end to the lower neck region 19 of the body 12, which may be accomplished by attaching with thread or wire stitching.

If neck articulation is desired, the support mechanisms 24 may be made of anything that is both flexible enough that it can be manipulated by hand and rigid enough to retain the adjustments made to it while supporting the weight of the head 16. One example of a suitable material for support mechanisms 24 is flexible or articulated metal tubing, which is flexible as well as extendable and compressible. Thus, the support mechanisms 24 may be adjustable such that the head 16 can be placed in different positions, thereby providing an articulated neck. In another embodiment, there may be only one flexible support tube 40 (shown in dashed lines) which provides the necessary adjustability needed for an articulated neck.

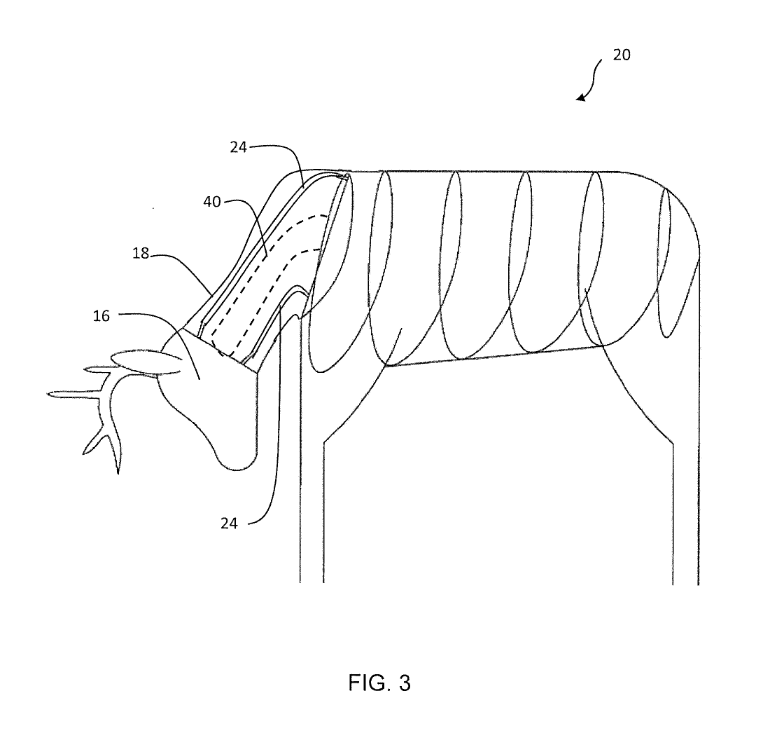

In either embodiment, the head 16 may be positioned close to the ground with the neck 18 angled downward, so that it gives the appearance that the deer decoy 20 is grazing or feeding, as shown in FIG. 3. The head 16 can also be positioned in an upright looking position, as shown in FIG. 2, but the support mechanisms 24 allow for greater adjustability than just feeding or looking positions. The head 16 of deer decoy 20 can be placed in a turned position relative to the body 12 thereby increasing the realistic representation of the deer decoy 20. The multi-adjustable support mechanisms 24 provide increased set-up options for the user and allow the user to optimize the position of the head 16 of deer decoy 20 to correlate with the terrain or environment in which the decoy 20 is deployed.

In another embodiment illustrated in FIG. 2, the neck 18 may not be articulated, in which case the support mechanisms 24 are rigid as opposed to flexible. The neck 18 may be a stand-alone piece that has a truncated conical shape and is removably attached to both the lower neck region 19 of the body 12 and the head 16. In this embodiment the neck 18 is rotatable which provides at least two different positions for the head 16 of the decoy 20. The base of neck 18 would be angled such that connecting the neck as shown in FIG. 2 results in the decoy 20 having an upward extending neck, appearing to be in a looking state, and rotation of the neck 18 by 180° results in the decoy 20 having a downward extending neck, appearing to be in a feeding position. The connections between the neck 18 and the body 12 and head 16 may be any suitable connection that allows for the rotation of the neck 18 as described. In a preferred embodiment, strong magnets sewn into the various abutting surfaces provide the desired adjustability

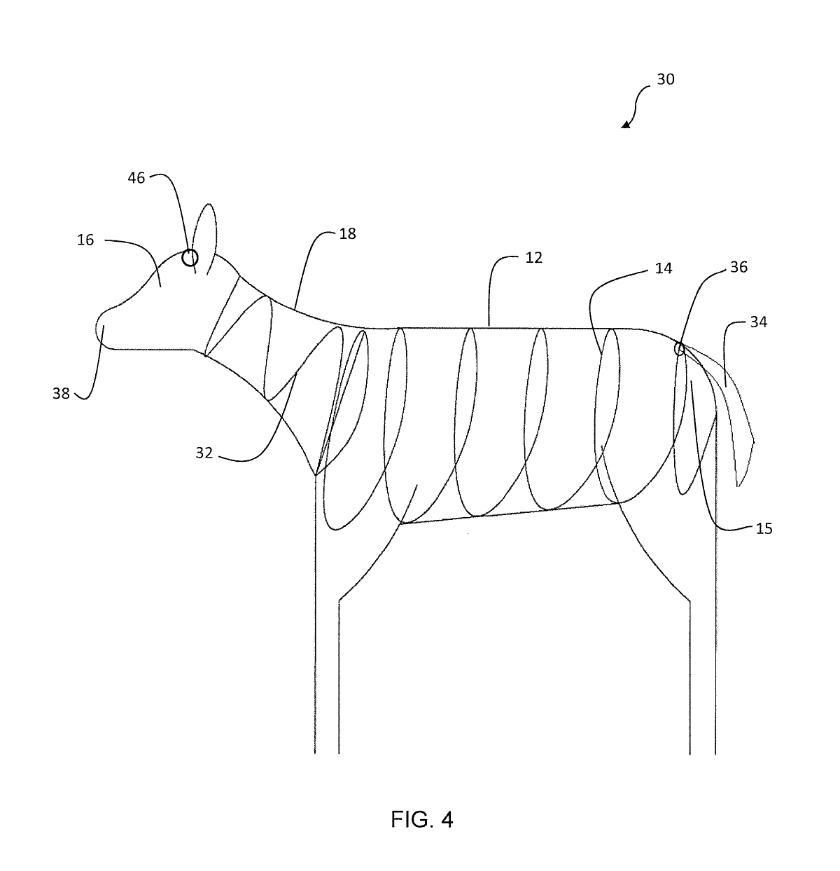

Antlers 28, which are positioned on the top of the head 16 of the deer decoy 20, may be removable. The antlers 28 may be constructed, for example, from a thin hollow plastic or a printed and sewn fabric with a polyester fill which is reinforced with an internal adjustable wire. Any suitable means which allows the antlers 28 to be selectively removed and re-attached can be used. For example strong magnets, Velcro (hook and loop), or various clips may be used. If magnet connections are used, magnets 44 may be attached to the base of the antlers 28 and may removably connect to a piece of metal 46 that is permanently attached to the top area of the head 16 of decoys 10, 20, 30, as shown in FIG. 1. The removability of the antlers allows the decoys 10, 20, 30 to be used as either a male or female. FIG. 4 shows deer decoy 30 where the antlers 28 have been temporarily removed, for example, from the piece of metal 46.

FIG. 4 illustrates a side view of a deer decoy 30 with the internal structure shown, according to yet another embodiment. Deer decoy 30 has many of the features described in relation to deer decoys 10, 20 however, deer decoy 30 includes a collapsible or compressible neck 18 and head 16. In this embodiment, the neck 18 and head 16 may be constructed similar to the body 12, in that a two dimensional fabric material that covers a coil spring 32 is made as a hollow piece which can be folded flat unless it is pressed into a three-dimensional form by the expansion of the coil spring 32. The coil spring 32 may extend from the base of the neck 18 to the nose area 38 of the head 16. Alternatively, the coil spring 32 may only extend to the bottom of the head 16, as shown in FIG. 4. In which case, the head 16 may be filled with polyester batting, foam, down, or other materials which would tend to inflate the head 16 to its full three-dimensional shape.

In the embodiment illustrated in FIG. 4, the coil spring that provides the three-dimensional structure to the head 16 and neck 18 may be the same coil spring that provides the three-dimensional shape to the body 12. Thus, the coil spring would extend from the nose region 38 all the way to the tail region 15 as a single unitary spring (not shown).

In the embodiment that uses a separate coil spring for the body 12 and the neck 18, the compressible body 12 can be attached to the neck 18 by any suitable means. For example, stitching, magnets, clips, zippers, or any combination of these could be used to connect the bottom of neck 18 to the lower neck region 19 of the body 12. Specifically, the base of neck 18 may be attached directly to the portion of the coil spring 14 located at the lower neck region 19 with thread or wire stitching. In an embodiment similar to that described in relation to decoy 20 (FIG. 2), the neck 18 may be a stand-alone piece that is connected to the head 16 and body 12 via strong magnets and may include the rotational feature previously described.

The deer decoys 10, 20, and 30 may also include a removable tail 34, which is shown in an attached state in FIG. 4. The tail 34 may be attached to the tail region 15 of the body 12 by any suitable means. For example, magnets, clips, zippers, or any combination of these may be used to connect the tail 34 to the body 12. In the preferred embodiment, shown in FIGS. 4, and 6-8, magnet(s) 36 is permanently attached to the bottom side of tail 34 at its top end, as shown in FIG. 7. The magnet 36 is magnetically attracted to the coil spring 14, such that it provides a sufficiently strong connection point between the tail 34 and the body 12. Alternatively, the tail 34 may be permanently attached to the body 12, for example with thread stitching.

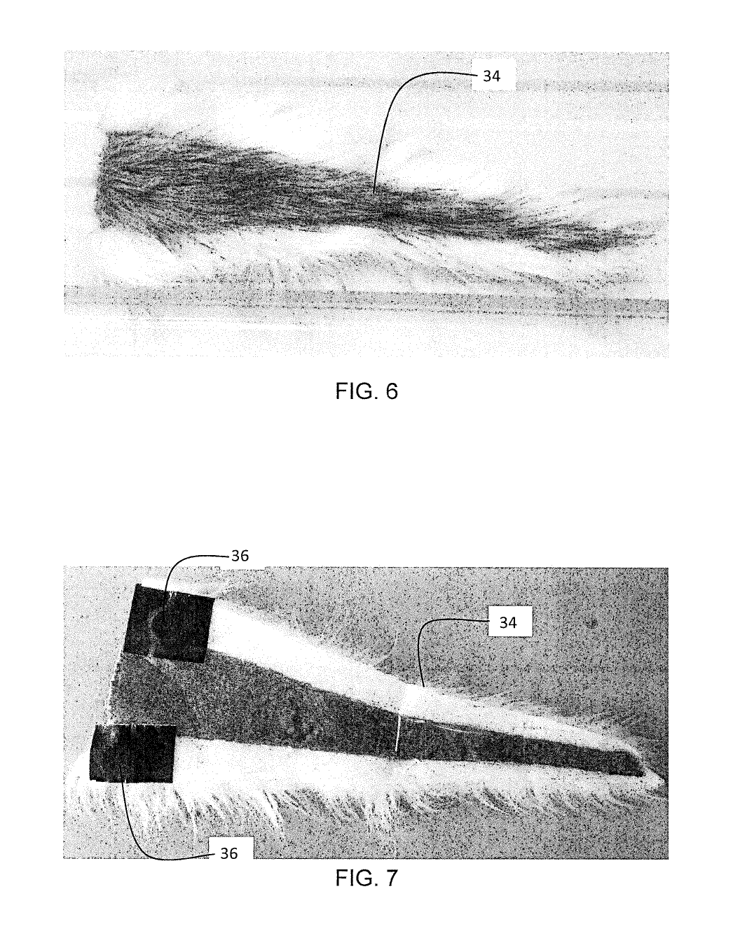

The tail 34 may be constructed of synthetic hair and may include several colors to imitate the real appearance of a deer tail, as shown in FIG. 6. The synthetic hair provides several unique advantages, such as allowing the wind to provide motion to the tail, thus increasing the realistic representation exhibited by the decoy. Additionally, the synthetic material used for the tail 34 would allow a hunter to add scent to the tail in order to help attract deer, as the material would readily soak up the liquid synthetic deer scents frequently used by hunters. The tail 34 may be constructed in an economical manner such that a user may reasonably discard the tail 34 after it is used with a deer scent, and purchase a new tail for the next hunt.

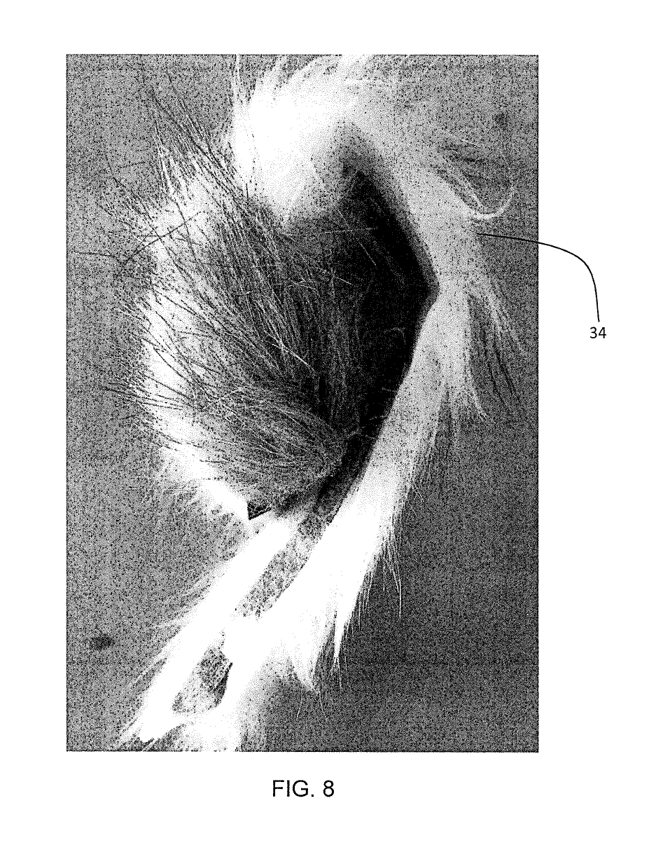

FIG. 8 shows the tail 34 in an alternate position than that shown in FIG. 4. The backing of the synthetic hair may be stiff enough that it allows a user to place the tail 34 in a desired position and the tail 34 will retain that position. Alternatively, the tail 34 may include a reinforcing member, such as a small gauge metal wire that extends the length of the tail 34 and provides the necessary stiffness to allow the tail 34 to retain its position once it is manipulated by the user.

One skilled in the art will realize that a virtually unlimited number of variations to the above descriptions are possible, and that the examples and the accompanying figures are merely to illustrate one or more examples of implementations.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

It will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments or implementations disclosed, but that such claimed subject matter may also include all embodiments or implementations falling within the scope of the appended claims, and equivalents thereof.

In the detailed description above, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Reference throughout this specification to “one embodiment,” “an embodiment,” “one implementation,” or “an implementation” may mean that a particular feature, structure, or characteristic described in connection with a particular embodiment or implementation may be included in at least one embodiment or implementation of claimed subject matter. Thus, appearances of the phrase “in one embodiment,” “an embodiment,” “one implementation,” or “an implementation” in various places throughout this specification are not necessarily intended to refer to the same embodiment or implementation, or to any one particular embodiment or implementation described. Furthermore, it is to be understood that particular features, structures, or characteristics described may be combined in various ways in one or more embodiments or implementations. In general, of course, these and other issues may vary with the particular context of usage. Therefore, the particular context of the description or the usage of these terms may provide helpful guidance regarding inferences to be drawn for that context.

What is claimed is:

1. An animal decoy comprising:
a body made of a material and generally configured to resemble a three dimensional animal torso, the body including a plurality of sleeves;
a compressible coil spring inside the body, with said spring configured to expand to press said material into a shape of said animal torso when released and which may be compressed to a generally flat position, with said coil spring extending from a tail region of said body to a first lower neck region of said body, with said coil spring forming the body extending from said tail region of said body to said first lower neck region of said body;
a head and neck generally configured to resemble a three dimensional animal head and neck, where the head and neck is made of a unitary piece of a three-dimensional material, and where the head and neck portion is connected to the body by a connection, wherein the connection comprises a first magnet; and
a plurality of poles, each pole in the plurality of poles having a first end configured to be inserted into the ground for support of the animal decoy and a second end configured to be inserted into a sleeve of the plurality of sleeves.

2. The animal decoy of claim 1, further comprising:
a set of antlers removably coupled to a top area on the head of the animal decoy.

3. The animal decoy of claim 2, further comprising:
a second magnet permanently attached to a bottom end of one of the antlers, wherein the second magnet removably engages a piece of metal that is permanently attached to the top area on the head of the animal decoy.

4. The animal decoy of claim 1, further comprising:
a tail removably coupled to a tail region of the body of the animal decoy.

5. The animal decoy of claim 4, further comprising:
a third magnet permanently attached to a bottom side of the tail, wherein the third magnet removably engages the compressible coil spring inside the body of the animal decoy.

6. An animal decoy comprising:
a body made of a first section of material and generally configured to resemble a three dimensional animal torso, the body including a plurality of sleeves;
a compressible coil spring inside the body with the coil spring configured to expand to press the first section of material into a shape of the animal torso when released and which may be compressed to a generally flat position, with said coil spring extending from a tail region of the body, to a lower neck region of said body, with the coil spring forming the body extending from the tail region of the body to the lower neck region of the body;
a neck made of a second section of material and generally configured to resemble a three dimensional animal neck, where the neck comprises an adjustable support mechanism inside the neck which can be manually positioned into different stationary positions, and where the neck is connected to the body by a first connection, wherein the first connection comprises a first magnet;
a head generally configured to resemble a three dimensional animal head, and where the head is connected to the neck by a second connection, wherein the second connection comprises a second magnet;
a plurality of poles, each pole in the plurality of poles having a first end configured to be inserted into the ground for support of the animal decoy and a second end configured to be inserted into a sleeve of the plurality of sleeves.

7. The animal decoy of claim 6, further comprising:
a set of antlers removably coupled to a top area on the head of the animal decoy.

8. The animal decoy of claim 7, further comprising:
a third magnet permanently attached to a bottom end of one of the antlers, wherein the third magnet removably engages a piece of metal that is permanently attached to the top area on the head of the animal decoy.

9. The animal decoy of claim 6, further comprising:
a tail removably coupled to a tail region of the body of the animal decoy.

10. The animal decoy of claim 9, further comprising:
a fourth magnet permanently attached to a bottom side of the tail, wherein the fourth magnet removably engages the compressible coil spring inside the body of the animal decoy.

11. An animal decoy comprising:
a body made of a first section of material and generally configured to resemble a three dimensional animal torso, the body including a plurality of sleeves;
a first compressible coil spring inside the body with the first coil spring configured to expand to press the first section of material into a shape of the animal torso when released and which may be compressed to a generally flat position, with the first coil spring extending from a tail region of the body to a lower neck region of said body, with the first coil spring forming the body extending from the tail region of the body to the lower neck region of the body;
a neck and a head made of a second section of material and generally configured to resemble a three dimensional animal neck and head;
a second compressible coil spring inside the neck and head with the second coil spring configured to expand to press the second section of material into a shape of the animal neck and head when released and which may be compressed to a generally flat position, with the second coil spring extending from a second lower neck region located on the neck to a nose region located on the head, with the second coil spring forming the neck and head extending from the second lower neck region of the neck to the nose region of the head;
where the neck is connected to the body by a connection, wherein the connection comprises a first magnet;
a plurality of poles, each pole in the plurality of poles having a first end configured to be inserted into the ground for support of the animal decoy and a second end configured to be inserted into a sleeve of the plurality of sleeves.

12. The animal decoy of claim 11, further comprising:
a set of antlers removably coupled to a top area on the head of the animal decoy.

13. The animal decoy of claim 12, further comprising:
a second magnet permanently attached to a bottom end of one of the antlers, wherein the second magnet removably engages a piece of metal that is permanently attached to the top area on the head of the animal decoy.

14. The animal decoy of claim 11, further comprising:
a tail removably coupled to a tail region of the body of the animal decoy.

15. The animal decoy of claim 14, further comprising:
a third magnet permanently attached to a bottom side of the tail, wherein the third magnet removably engages the compressible coil spring inside the body of the animal decoy.
